(19) United States
(12) Patent Application Publication
(10) Pub. No.: US 2011/0240280 A1
(43) Pub. Date: Oct. 6, 2011

(54) ALUMINUM ALLOY BRAZING SHEET AND HEAT EXCHANGER

(75) Inventors: Takahiro IZUMI, Moka-shi (JP); Toshiki Ueda, Moka-shi (JP); Shimpei Kimura, Moka-shi (JP); Akihiro Tsuruno, Moka-shi (JP)

(73) Assignee: Kabushiki Kaisha Kobe Seiko Sho (Kobe Steel, Ltd.), Kobe-shi (JP)

(21) Appl. No.: 13/071,757

(22) Filed: Mar. 25, 2011

(30) Foreign Application Priority Data
Mar. 31, 2010 (JP) 2010-084701

(51) Int. Cl. F28F 7/00; B23K 35/24

(52) U.S. Cl. 165/185; 148/23

(57) ABSTRACT

The present invention provides an aluminum alloy brazing sheet that is applied particularly to a tube material of a heat exchanger and is excellent in brazability and erosion resistance.

The present invention is an aluminum alloy brazing sheet having a core material comprising an Al—Mn system alloy and a brazing filler metal comprising an Al—Si system alloy containing Fe by 0.45 mass % or less on one surface or both the surfaces of the core material and is characterized in that, after subjected to a brazing treatment for 3 minutes at 600° C.: the area ratio of eutectic Si that is the flow passage of the brazing filler metal in a cross section of a solidified brazing filler metal is 35% or less; and the grain size in the rolling direction at the center section in the sheet thickness direction of the core material is 80 μm or more.

### FIELD OF THE INVENTION

The present invention relates to: an aluminum alloy brazing sheet; and a heat exchanger for an automobile or the like using the aluminum alloy brazing sheet.

### BACKGROUND OF THE INVENTION

A heat exchanger such as a condenser, an evaporator, an intercooler, or the like mounted on an automobile has a structure assembled mostly by: combining flattened tubes constituting fluid passages with fins formed by corrugating a material sheet in the manner of piling them alternately and repeatedly; and fitting the tubes to a plate (header) produced by press-forming a material sheet so as to combine the fluid passages (refer to FIG. 1). The heat exchanger is produced by being brazed and heated in the state where the parts are assembled and thereby bonding the tubes to the fins and the tubes to the plate respectively. To such tubes, a plate, and fins, an aluminum alloy material for brazing or an aluminum alloy brazing sheet that is a clad material produced by using an aluminum alloy as a core material and laminating a brazing filler metal comprising an Al—Si system alloy thereon is applied. The parts are bonded to each other by filling the joint section of the parts with a brazing filler metal melted by brazing and heating (molten brazing filler metal) and forming a fillet. In the brazing of a tube and a plate of a heat exchanger, good brazability that does not cause a gap at a brazed joint (fitting section) so as not to cause leakage in a fluid passage of the heat exchanger are particularly required.

As a method for improving brazability, a method of forming a fillet by controlling the thickness of a brazing filler metal and the Si content of the brazing filler metal to prescribed values or more in an aluminum alloy brazing sheet and melting a sufficient quantity of the brazing filler metal by brazing and heating is considered. On the other hand, if the quantity of the molten brazing filler metal increases however, the brazing filler metal migrates into the core material and hence the Si content and the like of the brazing filler metal are controlled in order to optimize the quantity of the molten brazing filler metal. As a plate for a heat exchanger, an aluminum alloy brazing sheet wherein the Si concentration of the brazing filler metal is controlled to a relatively low level of 1.6 to 5.0 mass %, Mn is further added, the viscosity of the molten brazing filler metal is increased, and the fluidity is inhibited is disclosed (refer to JP-A No. 2008-303405 (claim 1, Paragraph 0019)).

Here, when a tube is formed from an aluminum alloy brazing sheet that is a sheet material, a joint is formed by: either roll-forming the aluminum alloy brazing sheet, overlapping both the hems on the outer surface and the inner surface, and brazing them; or bending both the hems into an L-shape toward the inside of the roll-formed shape, butting both the outer surfaces against each other, and brazing them. In the case of a heat exchanger using a tube produced by forming such an aluminum alloy brazing sheet, at a brazing treatment, a molten brazing filler metal on a plate tends to flow through the surface of the tube toward the side where a fin is bonded, the quantity of the molten brazing filler metal accumulating at the joint between the tube and the plate decreases, and hence there is a possibility of causing a gap at the joint.

In the case of the technology described in JP-A No. 2008-303405, since the viscosity of the molten brazing filler metal on the surface of a plate is raised, it may be said that the quantity of the brazing filler metal flowing from the plate up to the vicinity of a fin is very small. However, since the Si concentration of the brazing filler metal is relatively low and Mn is added to the brazing filler metal, even though the brazing filler metal is melted by brazing and heating, the fluidity of the molten brazing filler metal is reduced. Consequently, the quantity of the molten brazing filler metal flowing up to the joint between the plate and the tube and accumulating at the joint decreases and there is a possibility of causing a gap at the joint. In view of the above situation, appropriate brazability is required of an aluminum alloy brazing sheet used for a part of a heat exchanger, in particular applied to a tube material.

### SUMMARY OF THE INVENTION

The present invention has been established in view of the above problems and an object of the present invention is to provide an aluminum alloy brazing sheet that is applied particularly to a tube material of a heat exchanger and is excellent in brazability and erosion resistance.

In order to solve the above problems, an aluminum alloy brazing sheet according to the present invention is characterized by having a core material comprising an Al—Mn system alloy and a brazing filler metal comprising an Al—Si system alloy containing Fe by 0.45 mass % or less on one surface or both the surfaces of the core material wherein, after subjected to a brazing treatment for 3 minutes at 600° C.: the area ratio of eutectic Si in a cross section of a solidified brazing filler metal is 35% or less; and the grain size in the rolling direction at the center section in the sheet thickness direction of the core material is 80 μm or more.

By controlling an Fe content in a brazing filler metal to a prescribed value or less and increasing the grain size of a core material after brazing in this way, an aluminum alloy brazing sheet wherein the quantity of eutectic Si on the surface of the core material acting as a passage of the flow of the brazing filler metal when the brazing filler metal solidifies at the brazing is reduced is obtained. By so doing, at a brazing treatment, the molten brazing filler metal that has reached a brazing joint is inhibited from flowing out through the passage because the area of the passage through which the brazing filler metal flows is small while a sufficient quantity of the molten brazing filler metal flowing toward the brazing joint is secured. As a result, a sufficient quantity of the brazing filler metal accumulates at the brazing joint, the quantity of a fillet increases, and brazability can be improved.

Then, a heat exchanger according to the present invention is fabricated by brazing tubes produced by forming an aluminum alloy brazing sheet according to the present invention to a plate produced by forming a material sheet having a core material comprising an aluminum alloy and a brazing filler metal comprising an Al—Si system alloy on one surface or both the surfaces of the core material. Further, the heat exchanger may be fabricated by brazing fins produced by forming an aluminum material or an aluminum alloy to the tubes and the aluminum alloy brazing sheet according to the present invention may be applied to the material sheet too.

In this way, by applying an aluminum alloy brazing sheet excellent in brazability and erosion resistance to a tube material and moreover to a material sheet, a heat exchanger assembled with good brazability without causing erosion can be obtained.

An aluminum alloy brazing sheet according to the present invention makes it possible to obtain good brazability and a good erosion resistance. Then by applying such an aluminum alloy brazing sheet as a tube material and moreover as a material sheet, a heat exchanger not causing leakage at a joint between a tube and a plate when it is assembled and brazed can be obtained.

### BRIEF DESCRIPTION OF THE DRAWINGS

FIG. 1 is an enlarged perspective view of a substantial part of a heat exchanger explaining the state of assembling parts.

FIG. 2A is a schematic sectional view of an aluminum alloy brazing sheet according to an embodiment of the present invention. FIGS. 2B and 2C are sectional views for schematically explaining an area ratio of eutectic Si in a brazing filler metal of an aluminum alloy brazing sheet after subjected to a brazing treatment; FIG. 2B represents the case where the area ratio of eutectic Si is small and FIG. 2C represents the case where the area ratio of eutectic Si is large.

FIGS. 3A and 3B are schematic views of a brazed joint structure for evaluating brazability in an example; FIG. 3A is a perspective view and FIG. 3B is a sectional view illustrating the site where the cross sectional area of a fillet at a brazed joint of a tube and a plate is measured.

FIGS. 4A to 4D are schematic views of a brazed joint structure for evaluating brazability in an example; FIG. 4A is a perspective view and FIGS. 4B to 4D are enlarged sectional views for explaining the specifications of the joint of a tube.

### DETAILED DESCRIPTION OF THE PREFERRED EMBODIMENTS

Embodiments for realizing an aluminum alloy brazing sheet and a heat exchanger according to the present invention are explained hereunder.

### [Aluminum Alloy Brazing Sheet]

In an aluminum alloy brazing sheet according to the present invention, a brazing filler metal is clad on one surface or both the surfaces of a core material comprising an aluminum alloy and, when it is applied to a tube material of a heat exchanger for example, it is preferable that the brazing filler metal is applied on the surface that faces outside when it is formed. A sectional view of an aluminum alloy brazing sheet having a brazing filler metal on one surface is schematically illustrated in FIG. 2A. With regard to the thickness of an aluminum alloy brazing sheet, in the case of a tube material in particular, as the thickness reduces, the weight of a produced heat exchanger reduces but strength and corrosion resistance come to be hardly retained and hence a preferable thickness is in the range of 0.15 to 0.50 mm. Further, in the case of applying an aluminum alloy brazing sheet to a material sheet of a heat exchanger, a preferable thickness is in the range of 0.50 to 1.5 mm.

Factors constituting an aluminum alloy brazing sheet according to the present invention are explained hereunder.

### [Core Material]

### (Core Material Mn: 0.6 to 2.0 Mass %)

The core material of an aluminum alloy brazing sheet according to the present invention is formed from an Al—Mn system alloy that: is generally used as a core material or an aluminum alloy material for brazing; and has a high strength and a relatively good corrosion resistance among aluminum alloys. More specifically, it is preferable that Mn is contained by 0.6 to 2.0 mass %. Mn forms an Al—Mn—Si system intermetallic compound and enhances the strength after brazing. If an Mn content is less than 0.6 mass %, the effect is low and, when Si is contained, the Al—Mn—Si system intermetallic compound reduces, the quantity of solid solution Si increases, and hence there is a possibility that the solidus temperature of the core material lowers and the core material melts while an aluminum alloy brazing sheet is brazed and heated. On the other hand, if an Mn content exceeds 2.0 mass %, there is a possibility that the quantity of a coarse intermetallic compound formed during casting increases and the workability of an aluminum alloy brazing sheet deteriorates.

The core material of an aluminum alloy brazing sheet according to the present invention may be an aluminum alloy further containing one or more kinds selected from the group consisting of Si: 1.0 mass % or less, Cu: 1.0 mass % or less, Mg: less than 0.5 mass %, and Ti: 0.35 mass % or less. As an aluminum alloy satisfying the conditions, a 3000 system aluminum alloy stipulated in JIS may be adopted.

### (Core Material Si: 1.0 Mass % or Less)

Si dissolves in an aluminum alloy and enhances the strength of the aluminum alloy. Further, Si forms an Al—Mn—Si system intermetallic compound and enhances the strength after brazing. Moreover, when Si coexists with Mg, Si forms Mg₂Si and enhances the strength after brazing. In order to exhibit the effects sufficiently, it is preferable that an Si content is 0.3 mass % or more. On the other hand, Si lowers the solidus temperature of an aluminum alloy and hence, if an Si content exceeds 1.0 mass %, there is a possibility that a core material melts while an aluminum alloy brazing sheet is brazed and heated.

### (Core Material Cu: 1.0 Mass % or Less)

Cu dissolves in an aluminum alloy and enhances the strength of the aluminum alloy. In order to exhibit the effects sufficiently, it is preferable that a Cu content is 0.3 mass % or more. Further, since Cu has the function of making the potential of an aluminum alloy noble, the potential of a core material comes to be nobler than that of an aluminum alloy as a brazing filler metal, hence the brazing filler metal sacrificially prevents the core material from corroding, and Cu improves the corrosion resistance of an aluminum alloy brazing sheet. On the other hand, since Cu lowers the solidus temperature of an aluminum alloy, if a Cu content exceeds 1.0 mass %, there is a possibility that a core material melts while an aluminum alloy brazing sheet is brazed and heated.

(Core Material Mg: Less than 0.5 Mass %)

Mg dissolves and precipitates in an aluminum alloy and enhances the strength of the aluminum alloy. By coexisting with Si in particular, Mg forms Mg₂Si and enhances the strength after brazing. On the other hand, since Mg has the function of lowering the effect of flux for brazing, if an Mg content is 0.5 mass % or more, Mg diffuses up to a brazing filler metal during brazing and brazability deteriorates considerably.

### (Core Material Ti: 0.35 Mass % or Less)

Ti forms a Ti—Al system chemical compound and disperses in layers. Since the potential of the Ti—Al system chemical compound is noble, corrosion takes a layered appearance and there is the effect that the corrosion (pitting corrosion) hardly advances in the thickness direction. In order to exhibit the effect sufficiently, it is preferable that a Ti content is 0.05 mass % or more. On the other hand, if a Ti content exceeds 0.35 mass %, there is a possibility that a coarse intermetallic compound is formed and hence the workability of an aluminum alloy brazing sheet deteriorates.

The core material of an aluminum alloy brazing sheet according to the present invention may contain Fe: 0.5 mass % or less, Zn: 0.2 mass % or less, and Cr: 0.2 mass % or less as unavoidable impurities.

### [Brazing Filler Metal]

### (Brazing Filler Metal Si: 4 to 13 Mass %)

It is preferable that the brazing filler metal of an aluminum alloy brazing sheet according to the present invention comprises an Al—Si system alloy and has a Si content of 4 to 13 mass % in the same way as an aluminum alloy for: a brazing filler metal laminated on an ordinary aluminum alloy brazing sheet; or a brazing filler metal generally used for the brazing of an aluminum alloy material for brazing. Si has the functions of lowering the solidus temperature of an aluminum alloy and enhancing fluidity at a brazing temperature. If an Si content is less than 4 mass %, the quantity of a flowing brazing filler metal is insufficient and brazing failure is caused. On the other hand, if an Si content exceeds 13 mass %, the composition comes to be hyper-eutectic, and hence there is a possibility that coarse primary crystal Si is generated and the workability of an aluminum alloy brazing sheet deteriorates.

### (Brazing Filler Metal Fe: 0.45 Mass % or Less)

In an Al—Si system alloy constituting the brazing filler metal of an aluminum alloy brazing sheet according to the present invention, an Fe content is controlled to 0.45 mass % or less. Fe forms an Al—Fe system intermetallic compound and the Al—Fe system intermetallic compound functions as product nuclei of an α phase when the brazing filler metal solidifies at a brazing treatment. If an Fe content in a brazing filler metal exceeds 0.45 mass %, the quantity of the Al—Fe system intermetallic compound acting as product nuclei increases, hence the number of the α phase increases, the α phase is fractionized, and the quantity of eutectic Si crystallizing at the interface of the a phase increases (refer to FIG. 2C). That is, a large quantity of the brazing filler metal crystallizes as eutectic Si in the surface layer of an aluminum alloy brazing sheet (on the surface of a core material) after subjected to brazing, the quantity of the brazing filler metal constituting a fillet reduces, and thus the brazability deteriorates. Consequently, an Fe content is controlled to 0.45 mass % or less.

The brazing filler metal of an aluminum alloy brazing sheet according to the present invention may be an aluminum alloy further containing one or more kinds selected from the group consisting of Zn: 7.0 mass % or less, Mg: 3.0 mass % or less, and Ti: 0.3 mass % or less.

### (Brazing Filler Metal Zn: 7.0 Mass % or Less)

Zn has the functions of lowering the solidus temperature of an aluminum alloy and increasing fluidity at a brazing temperature. Further, Zn makes the potential of an aluminum alloy base and can improve corrosion resistance from the side of an aluminum alloy brazing sheet (core material) where the brazing filler metal is laminated. In order to exhibit the effects sufficiently, it is preferable that a Zn content is 0.1 mass % or more. On the other hand, if a Zn content exceeds 7.0 mass %, there is a possibility that the workability of the aluminum alloy brazing sheet deteriorates, and corrosion resistance rather deteriorates due to self-corrosion.

### (Brazing Filler Metal Mg: 3.0 Mass % or Less)

Mg, similarly to Zn, has the functions of lowering the solidus temperature of an aluminum alloy and increasing the fluidity at a brazing temperature. Further, Mg has the effect of removing an oxide film on a brazing filler metal surface by evaporating in a brazing atmosphere during vacuum brazing. In order to exhibit the effects sufficiently, it is preferable that an Mg content is 0.1 mass % or more. On the other hand, if an Mg content exceeds 3.0 mass %, there is a possibility that contamination caused by Mg in the atmosphere advances in vacuum brazing, the function of flux is diminished, thus brazability deteriorates, and the workability of an aluminum alloy brazing sheet deteriorates.

### (Brazing Filler Metal Ti: 0.3 Mass % or Less)

Ti has the function of reducing the size of crystal grains at casting. In order to exhibit the effect sufficiently, it is preferable that a Ti content is 0.01 mass % or more. On the other hand, if a Ti content exceeds 0.3 mass %, a coarse intermetallic compound is formed and hence there is a possibility that the workability of an aluminum alloy brazing sheet deteriorates.

The brazing filler metal of an aluminum alloy brazing sheet according to the present invention may contain Cu, Mn, and Cr by 0.2 mass % or less respectively as unavoidable impurities.

In an aluminum alloy brazing sheet according to the present invention, it is preferable that a brazing filler metal is clad in a thickness of 15 μm or more per side at a clad ratio of 1% to 25%. If the thickness of a brazing filler metal is less than 15 μm, there is a possibility that the absolute quantity of the brazing filler metal is insufficient and the brazability deteriorates. On the other hand, if the thickness of a brazing filler metal is thick in excess of 25% in clad ratio, there is a possibility that the fluidity of the brazing filler metal is excessive, a part of it migrates into a core material, and the erosion of the core material occurs. Here, in the case of an aluminum alloy brazing sheet having a brazing filler metal on both the surfaces, the brazing filler metal on both the surfaces may be an aluminum alloy having identical components or aluminum alloys having components different from each other. In the case of an aluminum alloy brazing sheet applied to the material sheet of a heat exchanger for example, it is possible to use an Al—Si—Zn system alloy to which Zn is added on the surface that faces outside (on the side of a corrosive environment) and an Al—Si system alloy on the other surface when it is assembled into a heat exchanger.

### [Sacrificial Anode Material]

In an aluminum alloy brazing sheet according to the present invention, it is also possible to: apply the above brazing filler metal on one surface of the core material and a sacrificial anode material on the other surface; and improve corrosion resistance from the side of the other surface. When a heat exchanger is fabricated with an aluminum alloy brazing sheet having such a sacrificial anode material, parts are formed so that the surface having the sacrificial anode material may be on the side of a corrosive environment.

As a sacrificial anode material used for an aluminum alloy brazing sheet according to the present invention, a known material comprising aluminum or an aluminum alloy may be used and the thickness is not particularly limited. In order to obtain the effect of improving corrosion resistance sufficiently, it is preferable that the thickness is 15 μm or more and the clad ratio is 1% to 25%. As the aluminum alloy, an Al—Zn system alloy containing Zn by 6.0 mass % or less and an alloy produced by adding Mn, Si, Mg, and the like to an Al—Zn system alloy or an aluminum material are named for example.

### [Heat Exchanger]

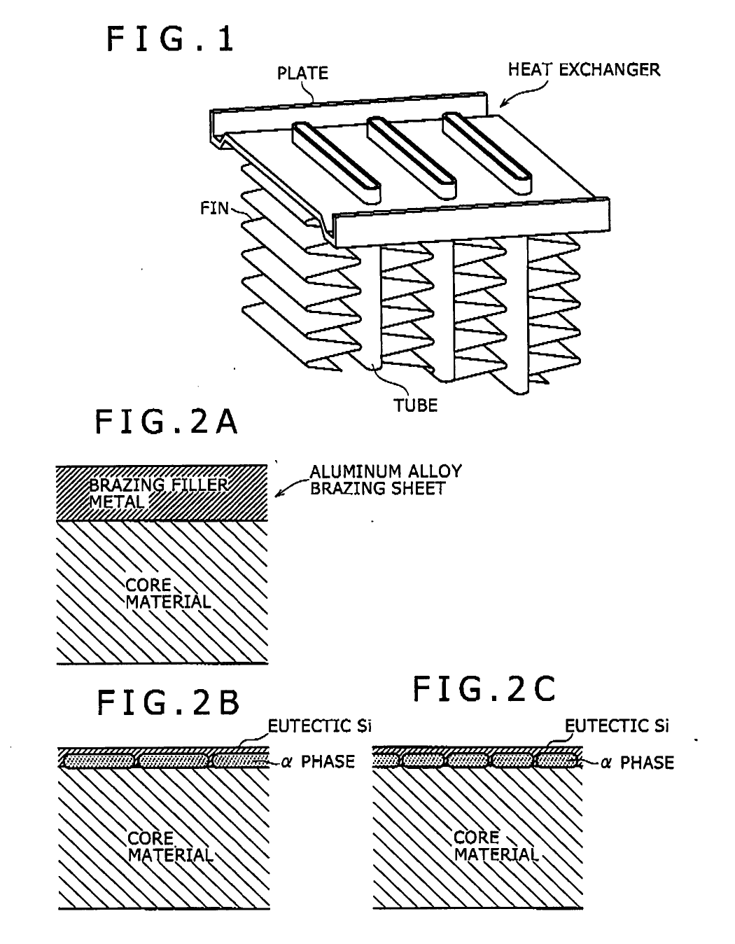

A heat exchanger according to the present invention is produced as follows for example. An aluminum alloy brazing sheet (tube material) according to the present invention is roll-formed into a flattened tube. Here, the tube material has a brazing filler metal at least outside. Another aluminum alloy brazing sheet or an aluminum alloy brazing sheet according to the present invention (material sheet) is press-formed into a plate. A sheet material comprising aluminum or aluminum alloy for brazing (called an aluminum alloy material) is corrugated into fins. The aluminum alloy material used for fins is not particularly limited but it is preferable that the thickness is 0.05 to 0.3 mm and an aluminum alloy brazing sheet having a brazing filler metal comprising an Al—Si system alloy or an Al—Si—Zn system alloy on both the surfaces may also be used. As illustrated in FIG. 1, a heat exchanger is produced by piling tubes and fins alternately, combining them by fitting ends of the tubes to a plate, and brazing them in the state by an ordinary method. Here, as Al—Si system alloys constituting the brazing filler metals applied on the surfaces of parts, alloys that melt at comparable temperatures are used so that the joints of tubes (joints between tube materials), tubes and a plate, and tubes and fins may be brazed simultaneously.

### (Area Ratio of Eutectic Si in Solidified Brazing Filler Metal: 35% or Less)

In the production of a heat exchanger according to the present invention, parts are bonded to each other by: filling the gaps at the joints and the overlapping portions between the parts with a brazing filler metal melted by brazing and heating; thus forming a fillet; and solidifying the brazing filler metal. The molten brazing filler metal flows on the surface of the parts, namely an aluminum alloy brazing sheet according to the present invention, most of the molten brazing filler metal separates from a core material or some of the brazing filler metal accumulates at the joints and the like, thereby a sufficiently large fillet is formed, and brazability improves. That is, since most of the brazing filler metal flows away from the regions other than the joints and the like on the surface of the aluminum alloy brazing sheet (core material), the core material is neither corroded nor eroded by the migration of brazing filler metal. It is difficult to directly measure the quantity of the brazing filler metal that melts, does not flow away from the surface, and stays at the regions other than the joints and the like at the brazing treatment of an aluminum alloy brazing sheet. In the present invention therefore, the fluidity of a brazing filler metal is measured from the proportion of eutectic Si in the melted and solidified brazing filler metal by observing a cross section of an aluminum alloy brazing sheet after subjected to a brazing treatment.

An Al—Si alloy constituting a brazing filler metal melts by brazing and heating and flows on the surface of an aluminum alloy brazing sheet. Then, when the heating finishes and the temperature lowers, firstly an α phase (Al) grows, and secondly eutectic Si is crystallized along the interface of the α phase and the Al—Si alloy solidifies (refer to FIG. 2B). Consequently, the eutectic Si crystallizing on the core material of an aluminum alloy brazing sheet after subjected to a brazing treatment (after cooled) is regarded as the region where the Al—Si alloy melts certainly during brazing and heating. If the ratio of the quantity of the eutectic Si to the quantity of the brazing filler metal having solidified on the core material, namely the sum of the quantities of the α phase and the eutectic Si, is small, it is possible to judge that a sufficient quantity of the molten brazing filler metal flows to a joint between aluminum alloy brazing sheets or a joint between an aluminum alloy brazing sheet and another member, the molten brazing filler metal that has reached the joint is inhibited from flowing out from the joint through the molten brazing filler metal remaining on the core material, and a sufficiently large fillet can be formed at the joint. More specifically, it means that, in the state of being cooled after heated for 3 minutes at 600° C., the area ratio of eutectic Si to the sum of the eutectic Si and an α phase is 35% or less on the cross section of the surface layer of an aluminum alloy brazing sheet on the side where the brazing filler metal is applied. In a thin aluminum alloy brazing sheet like a tube material, if an area ratio (called an area ratio of eutectic Si) exceeds 35%, the quantity of a brazing filler metal forming a fillet is small and brazability is insufficient.

An area ratio of eutectic Si can be obtained by, after an aluminum alloy brazing sheet is heated by a method similar to a known brazing treatment (after heated for 3 minutes at 600° C. and cooled): cutting out a specimen; observing the side of the aluminum alloy brazing sheet where a brazing filler metal is applied on the cut surface with an optical microscope; and measuring the areas of eutectic Si and an α phase in a region where the eutectic Si is observed. An area ratio of eutectic Si may be computed also by subjecting an optical photomicrograph to image analysis for example.

In order to reduce the quantity of eutectic Si crystallizing on the core material of an aluminum alloy brazing sheet after a brazing treatment, it is desirable to grow an α phase large and reduce the number when a brazing filler metal solidifies. Since eutectic Si crystallizes along the interface of an α phase that has been formed beforehand as stated above, if each piece of the α phase is large and the number of the α phase per area on the surface of an aluminum alloy brazing sheet is small as illustrated in FIG. 2B, the total area of the interface of the α phase where the eutectic Si can crystallize reduces. When such an aluminum alloy brazing sheet is used as a material sheet, most of molten brazing filler metal flows on a core material and passes through and the quantity of the brazing filler metal for forming a fillet at a joint with a tube increases. When it is used as a tube material, the flow of the molten brazing filler metal from a plate is inhibited and the quantity of the brazing filler metal for forming a fillet at a joint with the plate increases likewise. In contrast, if the number of an α phase is large and each piece of the α phase is small as illustrated in FIG. 2C, the total area of the interface of the α phase where eutectic Si can crystallize per area on the surface of an aluminum alloy brazing sheet increases. When it is used as a material sheet, most of the molten brazing filler metal does not flow on a core material and the quantity of the brazing filler metal for forming a fillet at a joint with a tube reduces. When it is used as a tube material, the flow of the molten brazing filler metal from a plate advances and the quantity of the brazing filler metal for forming a fillet at a joint with a tube reduces. In order to reduce the number of an α phase when a molten brazing filler metal solidifies, it is desirable to reduce the number of an Al—Fe system intermetallic compound acting as product nuclei of an α phase in the molten brazing filler metal. That is, it is desirable to reduce the number of an Al—Fe system intermetallic compound precipitating in the brazing filler metal of an aluminum alloy brazing sheet according to the present invention. To that end, as stated above, the content of Fe in an Al—Si system alloy constituting a brazing filler metal is controlled to 0.45 mass % or less. Further, as it will be described later, it is preferable that, in the production of an aluminum alloy brazing sheet, an Al—Fe system intermetallic compound is dissolved by applying a homogenizing heat treatment to an Al—Si system alloy ingot for a brazing filler metal at a prescribed temperature or higher and a finishing cold reduction rate is controlled to a prescribed value or lower so that the precipitated Al—Fe system intermetallic compound may not be crushed and thus the number may not increase.

(Grain Size of Core Material after Brazing Treatment: 80 μm or More in Length in Rolling Direction)

Further, the α phase of a brazing filler metal (Al—Si alloy) grows along the crystal orientation of a core material as a substrate. Consequently, in order to grow an α phase large and reduce the crystallization of eutectic Si, the length in a planar direction of the crystal grain size in the core material of an aluminum alloy brazing sheet according to the present invention is increased. More specifically, in the state of being cooled after heated for 3 minutes at 600° C., the grain size in the rolling direction at the center section in the sheet thickness direction of a core material is set at 80 μm or more. If the grain size of a core material after subjected to a brazing treatment is less than 80 μm, each piece of the α phase in a brazing filler metal does not grow sufficiently large, hence the number of the α phase per area on the surface of an aluminum alloy brazing sheet increases, the crystallization of eutectic Si increases, and a sufficiently large fillet is not formed. In order to sufficiently increase the grain size of a core material in a planar direction, as it will be described later, it is preferable that an intermediate annealing temperature and a finishing cold reduction rate are controlled into prescribed ranges respectively in the production of an aluminum alloy brazing sheet.

The crystal grain size of a core material can be measured in the same way as the measurement of the area ratio of eutectic Si stated above by: heating (heating for 3 minutes at 600° C. and cooling) an aluminum alloy brazing sheet by a method similar to a known brazing treatment; and thereafter cutting out a specimen. A crystal grain size is measured by: polishing the specimen from a plane on one side to a depth reaching the center section of the core material in the sheet thickness direction; etching the polished plane by an electrolyte; and observing the plane with an optical microscope of about 100 magnifications. Here, the center section of a core material in the sheet thickness direction means the region within ±25% of the thickness of the core material from the center in the sheet thickness direction.

### [Production Method]

An aluminum alloy brazing sheet according to the present invention is produced by a known method of producing a clad material. An example is explained hereunder.

Firstly, an ingot for a core material is obtained by: melting and casting an aluminum alloy having components of the core material of an aluminum alloy brazing sheet according to the present invention through continuous casting; milling the surface if needed; and homogenizing the aluminum alloy by a heat treatment. Similarly, an ingot for a brazing filler metal and an ingot for a sacrificial anode material if needed are obtained by the same method as the ingot for the core material.

The temperature at a homogenizing heat treatment applied to each ingot is set in accordance with the compositions of the ingot. It is preferable that the homogenizing heat treatment is applied particularly to an Al—Si system alloy ingot for a brazing filler metal at a temperature between 440° C. and 570° C. If the temperature is lower than 440° C., an Al—Fe system intermetallic compound scarcely dissolves and hence remains in quantities in the brazing filler metal when an aluminum alloy brazing sheet is formed. Consequently, at brazing, product nuclei of an α phase increase, eutectic Si also increases, and brazability deteriorates. On the other hand, if the temperature exceeds 570° C., there is a possibility that the ingot melts and cannot be used as a material regardless of the Si content and the like in the brazing filler metal.

Each ingot is formed into an aluminum alloy plate (or an aluminum plate) of a thickness in the ratio conforming to the clad ratio of an aluminum alloy brazing sheet by hot rolling or cutting according to the needs. Here, in the case of a thickest core material, the core material may be used in an ingot state. Successively, the aluminum alloy materials are piled up in conformity with the order of the lamination of an intended aluminum alloy brazing sheet, heated at a temperature of 400° C. or higher (preheating for hot rolling), thereafter pressed by hot rolling (clad rolling), and formed into an integrated sheet material. Successively, annealing is applied if needed and then a sheet of an intended thickness is obtained by applying cold rolling, intermediate annealing, and cold rolling. Here, the cold rolling is repeated while intermediate annealing is properly interposed in between until a desired sheet thickness is obtained. Further, finishing annealing may be applied after finishing cold rolling by which the final thickness is obtained.

Here, it is preferable that the intermediate annealing is applied at a temperature between 210° C. and 460° C. If the temperature is lower than 210° C., strain accumulated during the preceding cold rolling can be alleviated insufficiently and the size of crystal grains is reduced. On the other hand, if the temperature exceeds 460° C., a coarse Al—Mn system intermetallic compound precipitates in quantities in a core material, the Al—Mn system intermetallic compound acts as recrystallization nuclei, hence the number of crystal grains in the core material increases, and the size of the crystal grains is reduced.

Here, it is preferable that the processing rate (finishing cold reduction rate) at finishing cold rolling (cold rolling after the final intermediate annealing) is 20% to 70%. If the finishing cold reduction rate is lower than 20%, driving force for recrystallization is insufficient and an unrecrystallized (sub-grain) structure is formed. If sub-grains are formed in a core material in particular, a molten brazing filler metal diffuses into the sub-grains in the core material and erosion occurs at brazing. On the other hand, if the finishing cold reduction rate exceeds 70%: accumulated strain is excessive and hence crystal grains are fractionized and in particular the crystal grain size in a core material reduces; and an Al—Fe system intermetallic compound in a brazing filler metal is crushed and disperses and hence the number density increases.

### Example 1

Embodiments for realizing the present invention have heretofore been described. Examples which have verified the effects of the present invention are specifically explained hereunder in comparison with comparative examples which do not satisfy the requirements of the present invention. Note that, the present invention is not limited to the examples.

### (Production of Test Material)

Ingots are obtained by melting and casting aluminum alloys for core materials (C) and aluminum alloys for brazing filler metals (F), those having the compositions indicated in Table 1, and an aluminum alloy containing Zn by 3 mass % for a sacrificial anode material (S) through continuous casting. The surfaces of the ingots are ground, the ingots for the brazing filler metals and the sacrificial anode material are cut into thick plates of prescribed thicknesses conforming to clad ratios respectively, and then a homogenizing heat treatment is applied for 4 hours. The homogenizing heat treatment temperature is set: at 500° C. in the cases of the ingots for the core materials and the ingots (thick plates) for the sacrificial anode material; and at the temperatures indicated in Table 1 in the cases of the ingots (thick plates) for the brazing filler metals.

As aluminum alloy brazing sheets used as the tube materials and the plate materials, each of the aluminum alloy brazing sheets indicated by the construction “F/C” in Table 1 is constructed by overlaying a thick plate for a brazing filler metal (F) on one surface of an ingot for a core material (C). Further, each of the aluminum alloy brazing sheets indicated by the construction “F/C/S” is constructed by overlaying a thick plate for a sacrificial anode material (S) on the other surface of the ingot for the core material. Each of the overlaid ingots and others is preheated for 4 hours at 500° C., thereafter bonded with pressure by applying hot rolling, and thus an integrated sheet material is obtained. Then, each of the integrated sheet materials is cold-rolled continuously to a prescribed thickness, subjected to intermediate annealing for 4 hours at a temperature indicated in Table 1, and thereafter subjected to finishing cold rolling at a processing rate indicated in Table 1, and thus an aluminum alloy brazing sheet having a prescribed final thickness (each of the test materials Nos. 1 to 21) is obtained. Here, with regard to the test material No. 16, subsequent production processes and evaluation are not applied because the thick plate for the brazing filler metal melts through the homogenizing heat treatment (indicated with the symbol “-” in Table 1). Here, with regard to the tube materials, the thickness is set at 0.3 mm, the clad ratio of the brazing filler metals is set at 15%, and the clad ratio of the sacrificial anode material is set at 10%. With regard to the material sheets, the thickness is set at 2.0 mm, the clad ratio of the brazing filler metals is set at 10%, and the clad ratio of the sacrificial anode material is set at 10%. As each of the fin materials, an aluminum alloy sheet 0.1 mm in thickness is obtained by applying casting, a homogenizing heat treatment, preheating, hot rolling, cold rolling, intermediate annealing, and finishing cold rolling to a JIS 3003 alloy by an ordinary method.

### (Production of Brazing Heat-Treated Material)

A brazing heat-treated material is produced by retaining an obtained aluminum alloy brazing sheet (a tube material or a plate material) for 3 minutes at 600° C. in a nitrogen atmosphere and thereby simulating brazing and heating.

### (Measurement of Grain Size of Core Material)

A tube material subjected to a brazing heat treatment is cut, and polished from one surface to the center of the sheet thickness of the core material, and the polished plane is etched with an electrolyte and photographed with an optical microscope of 100 magnifications. The crystal grain size of the core material in the rolling direction is measured from the microphotographs by a section method. The grain size is measured at five sites and the average is indicated in Table 1.

### (Measurement of Area Ratio of Eutectic Si in Solidified Brazing Filler Metal)

Each of a tube material and a plate material subjected to a brazing heat treatment is cut, the side of the cut plane to which a brazing filler metal is applied is observed with an optical microscope, and the areas of the eutectic Si and the α phase in the region where the eutectic Si is observed are measured respectively. The percentage of the area of the eutectic Si to the sum of the areas of the eutectic Si and the α phase is computed and indicated in Table 1.

### (Evaluation of Erosion Resistance)

With regard to a tube material, two test materials are used: a brazing heat-treated material; and a test material produced by brazing and heating an aluminum alloy brazing sheet before brazing and heating, to which a processing rate of 10% is further added at finishing cold rolling, under the same conditions as the brazing heat-treated material. The test materials are cut and embedded into resin respectively. The cut faces are polished and the polished faces are observed with an optical microscope of 100 magnifications. The minimum thickness of a remaining core material is measured and the ratio of the thickness of the remaining core material to the thickness of the original core material (before brazing and heating) is computed. The case where the ratio of a remaining core material is 70% or more is represented with the symbol “◯”, and the case of less than 70% is represented with the symbol “X”. In both the cases where additional cold rolling is applied and not applied (0% and +10%), when the ratio of a remaining core material is 70% or more, the erosion resistance is rated as acceptable.

### (Fabrication of Brazed Joint Structure)

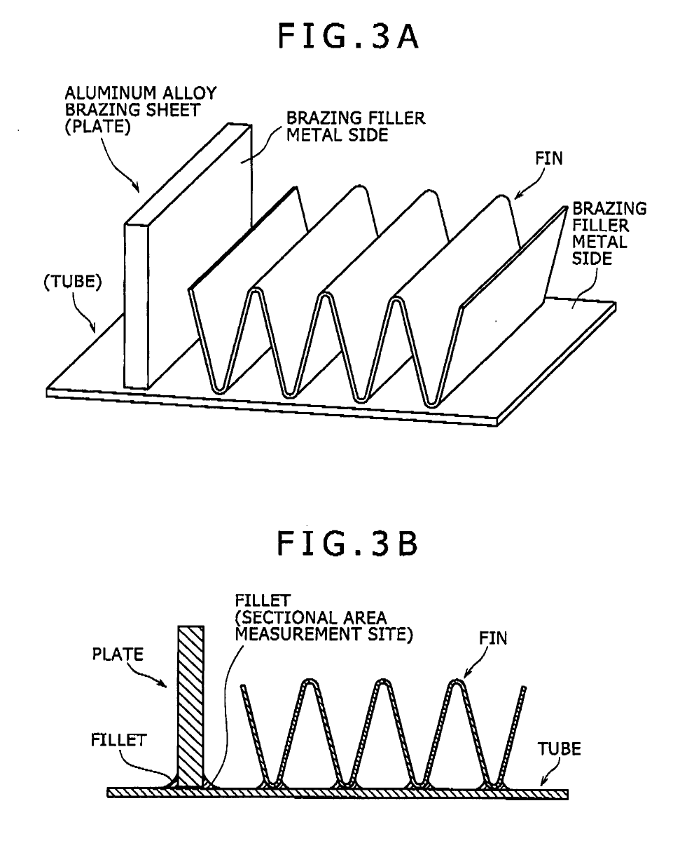

A tube and a plate are obtained by cutting a tube material into a size of 30 mm in length and 25 mm in width in the rolling direction and a plate material into a size of 20 mm in length and 25 mm in width in the rolling direction respectively as prescribed sizes. Fins are obtained by cutting and corrugating a fin material (an aluminum alloy plate). The surface of each of the tube and the plate on the brazing filler metal side is coated with fluoride flux of 10 g/m² and dried. Then, the tube and the plate are assembled together with the fins in the shape illustrated in FIG. 3A so as to have the combinations indicated in Table 1. More specifically, the tube is placed horizontally so that the brazing filler metal side may be directed upward, the plate is placed vertically on the tube, then the fins are mounted, and they are fixed. Here, the plate is placed on the tube so that the plane of the plate having the brazing filler metal may face the fins. In the case of the test material No. 21 however, fins are not placed and the structure is assembled with only the tube and the plate (a shape formed by removing the fins from the shape illustrated in FIG. 3A). Here, the parts the core materials and brazing filler metals of which have alloy compositions and production conditions identical to each other are combined together. The assembled parts are brazed and heated by retaining them for 3 minutes at 600° C. in a nitrogen atmosphere and the test materials (Nos. 1 to 15 and 17 to 21) of brazed joint structures are fabricated.

### (Evaluation of Brazability)

A test material of a brazed joint structure is cut along a line nearly in the center of the width direction, the joint of the tube and the plate (on the side of the brazing filler metal) on the cut plane (refer to FIG. 3B) is observed with an optical microscope of 100 magnifications, and a cross sectional area of the fillet at the joint is measured while the taken photographs are patched together. Brazability is rated as acceptable when the cross sectional area of a fillet is 0.2 mm² or more: rated as particularly excellent with the symbol “⊚” when it is 2.0 mm² or more; rated as excellent with the symbol “∘” when it is 1.0 mm² or more and less than 2.0 mm²; and rated as good with the symbol “Δ” when it is 0.2 mm² or more and less than 1.0 mm². They are indicated in Table 1. On the other hand, when the cross sectional area of a fillet is less than 0.2 mm², the brazability is rated as poor and indicated with the symbol “X”.

TABLE 1

| | | | | | | | Brazing filler metal | | | | | | | |
|---|---|---|---|---|---|---|---|---|---|---|---|---|---|---|
| | | | | | | | Alloy | | | Brazing sheet | | | | |
| | | Core material alloy | | | | | composition** | | Soaking | | | | Intermediate | Finishing cold |
| Test material | | composition** (mass %) | | | | | (mass %) | | temperature | Construction (note) | | | annealing | reduction |
| Classification | No | Si | Cu | Mn | Mg | Ti | Si | Fe | (° C.) | Plate | Tube | Fin | temperature (° C.) | rate (%) |
| Example | 1 | 0.7 | 0.5 | 1.7 | — | 0.15 | 10 | 0.25 | 500 | F/C | F/C | C | 340 | 45 |
| | 2 | 0.7 | 0.5 | 1.7 | — | 0.15 | 10 | 0.25 | 500 | F/C/S | F/C | C | 340 | 45 |
| | 3 | 0.7 | 0.5 | 1.7 | — | 0.15 | 10 | 0.25 | 500 | F/C/S | F/C/S | C | 340 | 45 |
| | 4 | 0.7 | 0.5 | 1.7 | 0.4 | 0.15 | 10 | 0.25 | 500 | F/C | F/C | C | 340 | 45 |
| | 5 | 0.7 | 0.5 | 1.7 | 0.4 | 0.15 | 10 | 0.25 | 500 | F/C/S | F/C | C | 340 | 45 |
| | 6 | 0.7 | 0.5 | 1.7 | — | 0.15 | 10 | 0.25 | 440 | F/C | F/C | C | 340 | 45 |
| | 7 | 0.7 | 0.5 | 1.7 | — | 0.15 | 10 | 0.25 | 560 | F/C | F/C | C | 340 | 45 |
| | 8 | 0.7 | 0.5 | 1.7 | — | 0.15 | 10 | 0.25 | 490 | F/C | F/C | C | 210 | 45 |
| | 9 | 0.7 | 0.5 | 1.7 | — | 0.15 | 10 | 0.25 | 490 | F/C | F/C | C | 460 | 45 |
| | 10 | 0.7 | 0.5 | 1.7 | — | 0.15 | 10 | 0.25 | 490 | F/C | F/C | C | 400 | 20 |
| | 11 | 0.7 | 0.5 | 1.7 | — | 0.15 | 10 | 0.25 | 490 | F/C | F/C | C | 400 | 70 |
| | 12 | 0.7 | 0.5 | 1.7 | 0.4 | 0.15 | 10 | 0.25 | 440 | F/C | F/C | C | 210 | 70 |
| Comparative | 13 | 0.7 | 0.5 | 1.7 | — | 0.15 | 10 | 0.5* | 500 | F/C | F/C | C | 340 | 45 |
| example | 14 | 0.7 | 0.5 | 1.7 | 0.4 | 0.15 | 10 | 0.5* | 500 | F/C | F/C | C | 340 | 45 |
| | 15 | 0.7 | 0.5 | 1.7 | — | 0.15 | 10 | 0.25 | 380 | F/C | F/C | C | 400 | 45 |
| | 16 | 0.7 | 0.5 | 1.7 | — | 0.15 | 10 | 0.25 | 580 | F/C | F/C | C | — | — |
| | 17 | 0.7 | 0.5 | 1.7 | — | 0.15 | 10 | 0.25 | 490 | F/C | F/C | C | 200 | 45 |
| | 18 | 0.7 | 0.5 | 1.7 | — | 0.15 | 10 | 0.25 | 490 | F/C | F/C | C | 500 | 45 |
| | 19 | 0.7 | 0.5 | 1.7 | — | 0.15 | 10 | 0.25 | 490 | F/C | F/C | C | 400 | 95 |
| | 20 | 0.7 | 0.5 | 1.7 | — | 0.15 | 10 | 0.25 | 490 | F/C | F/C | C | 400 | 15 |
| | 21 | 0.7 | 0.5 | 1.7 | 0.4 | 0.15 | 10 | 0.5* | 380 | F/C | F/C | — | 500 | 15 |

| | | | | | Evaluation | | |
|---|---|---|---|---|---|---|---|
| | | Core material | Solidified brazing filler | | Erosion resistance, | | |
| Test material | | grain size | metal eutectic Si area ratio (%) | | additional cold reduction | | |
| Classification | No | (μm) | Plate | Tube | 0% | +10% | Brazability |
| Example | 1 | 110 | 18 | 15 | ◯ | ◯ | ⊚ |
| | 2 | 110 | 18 | 15 | ◯ | ◯ | ⊚ |
| | 3 | 110 | 18 | 15 | ◯ | ◯ | ⊚ |
| | 4 | 105 | 21 | 18 | ◯ | ◯ | ⊚ |
| | 5 | 105 | 21 | 18 | ◯ | ◯ | ⊚ |
| | 6 | 110 | 20 | 17 | ◯ | ◯ | ⊚ |
| | 7 | 110 | 16 | 13 | ◯ | ◯ | ⊚ |
| | 8 | 110 | 23 | 20 | ◯ | ◯ | ⊚ |
| | 9 | 110 | 23 | 20 | ◯ | ◯ | ⊚ |
| | 10 | 110 | 8 | 5 | ◯ | ◯ | ⊚ |
| | 11 | 110 | 28 | 25 | ◯ | ◯ | ⊚ |
| | 12 | 105 | 33 | 30 | ◯ | ◯ | ⊚ |
| Comparative | 13 | 110 | 40* | 37* | ◯ | ◯ | X |
| example | 14 | 105 | 43* | 40* | ◯ | ◯ | X |
| | 15 | 110 | 39* | 36* | ◯ | ◯ | X |
| | 16 | — | — | — | — | — | — |
| | 17 | 70* | 42* | 39* | ◯ | ◯ | X |
| | 18 | 75* | 41* | 38* | ◯ | ◯ | X |
| | 19 | 40* | 43* | 40* | ◯ | ◯ | X |
| | 20 | 130 | 48* | 45* | X | X | X |
| | 21 | 130 | 53* | 50* | X | X | ⊚ |

**Remainder consisting of Al and unavoidable impurities.
*Outside the range of the present invention
(note)
C: Core material, F: Brazing filler metal, S: Sacrificial anode material

As indicated in Table 1, in each of the cases of the test materials Nos. 1 to 12, since the area ratio of the eutectic Si in the solidified brazing filler metal after a brazing treatment is in the range stipulated in the present invention, the erosion resistance and brazability is good. In other words, in any of the cases where a double-layered material (the test material No. 1 or another) having a brazing filler metal on one side is used, a triple-layered material (the test material No. 2 or 3) having a brazing filler metal on one side and a sacrificial anode material on the other side is used, and they are applied to a tube or a plate, sufficiently good properties are exhibited as an aluminum alloy brazing sheet for a heat exchanger.

In contrast, in each of the cases of the test materials Nos. 13 to 15 and 17 to 20, since the area ratio of the eutectic Si in the solidified brazing filler metal after a brazing treatment exceeds the range stipulated in the present invention, the quantity of the brazing filler metal for forming the fillet is insufficient and brazability is poor. Since the Fe content in the brazing filler metal is excessive in each of the cases of the test materials Nos. 13 and 14 and the homogenizing heat treatment temperature of the brazing filler metal is low in the case of the test material No. 15, a large quantity of the Al—Fe intermetallic compound distributes in the brazing filler metal and the area ratio of the eutectic Si in the brazing filler metal is large. Here, in the case of the test material No. 16, since the homogenizing heat treatment temperature of the brazing filler metal is too high and hence the thick plate melts, fabrication and evaluation are not applied as stated above. Further, since the intermediate annealing temperature of the aluminum alloy brazing sheet is outside the acceptable range in each of the cases of the test materials Nos. 17 and 18 and the finishing cold reduction rate is excessively high in the case of the test material No. 19, the crystal grain size in the core material is small and as a result the area ratio of the eutectic Si in the brazing filler metal increases. Meanwhile, in the case of the test material No. 20, sub-grains are formed because of the low finishing cold reduction rate, the molten brazing filler metal migrates into the sub-grains of the core material, erosion is caused, and the area ratio of the eutectic Si increases.

In the case of the test material No. 21, although the area ratio of the eutectic Si in the solidified brazing filler metal after the brazing treatment deviates from the range stipulated in the present invention, since fins are not included in the brazed joint structure, a fillet at the joint with fins does not exist on the surface of the tube, the fillet is formed only at the joint between the tube and the plate, and hence the size of the fillet is sufficiently large. In the case of the test material No. 21 however, since the Fe content in the brazing filler metal is excessive and the homogenizing heat treatment temperature of the brazing filler metal is low, the Al—Fe intermetallic compound distributes particularly abundantly in the brazing filler metal and moreover, since sub-grains are formed and erosion is caused because the finishing cold reduction rate of the aluminum alloy brazing sheet is low, the area ratio of the eutectic Si in the brazing filler metal is particularly high. Here, it is considered that, in the case of the test material No. 21, the crystal grain size of the core material does not reduce even though the intermediate annealing temperature is high because the finishing cold reduction rate is low.

### Example 2

### Fabrication of Brazed Joint Structure

With regard to each of the test materials Nos. 1 and 5 in Example 1 (refer to Table 1), the following brazed joint structure is fabricated in order to simulate the state where a tube is roll-formed into a flattened shape and both the hems are bonded (jointed). Aluminum alloy brazing sheets having the same specifications as the test material No. 1 in Example 1 are used for the test materials Nos. 1-2 to 1-7 and an aluminum alloy brazing sheet having the same specifications as the test material No. 5 in Example 1 is used for the test material No. 5-2. Further, aluminum alloy brazing sheets produced by the same method as the tube material and others are used for the fin materials of the test materials Nos. 1-5 and 5-2. With regard to the aluminum alloy brazing sheets for the fin materials: a JIS 3003 alloy is used for the core material in the same way as the case of an aluminum alloy plate; and an Al-10% Si alloy (refer to Table 1) that is the same brazing filler metal as the test materials No. 1 and others formed on both the surfaces at a clad ratio of 15% in a thickness of 0.1 mm in the same way as the case of the aluminum alloy plate is used for the brazing filler metal. The plate materials and the fin materials are cut into the same shapes as Example 1 and the fin materials are further corrugated to form fins.

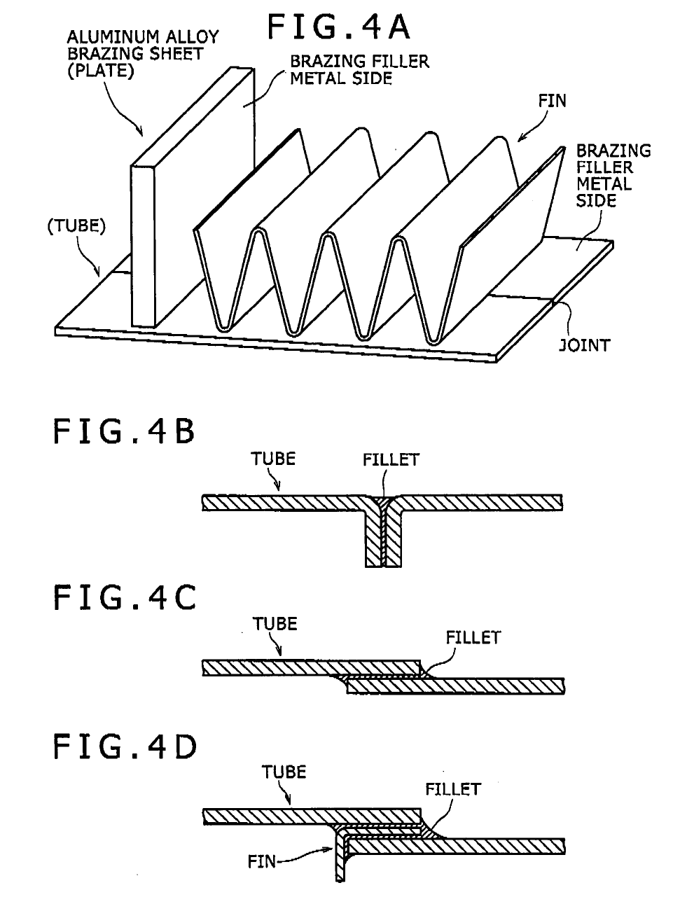

More specifically, a set of two sheets produced by cutting each of the tube materials of the test materials Nos. 1 and 5 into a size of 30 mm in length and 15 mm in width in the rolling direction are aligned in the width direction and are jointed at the hems (long sides). The joint of each of the tubes is formed by: “bending and butting” of bending the two sheets inside at the positions of 2.5 mm from both the edges into the shape of L in a sectional view and butting the outer surfaces (refer to FIG. 4B); “Overlaying” of overlaying both the hems 2.5 mm in width of the two sheets and butting the outer surface to the inner surface (refer to FIG. 4C); or “Sandwiching fin” of sandwiching a fin material (not shaped) between both the overlaid hems of a tube (refer to FIG. 4D) (indicated in Table 2). The surface of each of such parts on the brazing filler metal side is coated with fluoride flux of 10 g/m² and dried and the parts are assembled into the shape illustrated in FIG. 4A. More specifically, a jointed tube is placed horizontally so that the flat plane (the side illustrated as the upper side in FIGS. 4B to 4D) may be directed upward, a plate is placed vertically on the tube in the same way as Example 1, then fins are placed, and they are fixed. In each of the cases of the test materials Nos. 1-6 and 1-7, fins are not placed on a tube and only a plate is placed (a shape formed by removing fins from the shape illustrated in FIG. 4A). In the same way as Example 1, each of the test materials (Nos. 1-2 to 1-7 and 5-2) having a brazed joint structure is produced by retaining the assembled parts for 3 minutes at 600° C. in a nitrogen atmosphere and thereby brazing and heating them.

### (Evaluation of Brazability)

A test material of a brazed joint structure is cut in the vicinity of the joint of the tube and the cross sectional area of the fillet at the joint between the tube and the plate is measured in the same way as Example 1 (refer to FIG. 3B). The brazability is judged through the same criterion as Example 1 and the results are indicated in Table 2.

TABLE 2

| | | Brazing sheet | | | | |
|---|---|---|---|---|---|---|
| Test material | | construction (note) | | | Tube joint | Braz- |
| Classification | No. | Plate | Tube | Fin | specification | ability |
| Example | 1-2 | F/C | F/C | C | Bending and | ◯ |
| | | | | | butting | |
| | 1-3 | F/C | F/C | C | Overlaying | Δ |
| | 1-4 | F/C | F/C | C | Sandwiching | Δ |
| | | | | | fin | |
| | 1-5 | F/C | F/C | F/C/F | Sandwiching | Δ |
| | | | | | fin | |
| | 1-6 | F/C | F/C | — | Bending and | ⊚ |
| | | | | | butting | |
| | 1-7 | F/C | F/C | — | Overlaying | ◯ |
| | 5-2 | F/C | F/C | F/C/F | Sandwiching | ⊚ |
| | | | | | fin | |

(note)
C: Core material, F: Brazing filler metal

As indicated in Table 2, in the cases of the test materials Nos. 1-2 to 1-7 and 5-2, the brazability is good in the same way as the cases of the test materials Nos. 1 and 5 in Example 1. In particular, because the outer surface and the inner surface that is not covered with the brazing filler metal of the tube material are overlaid with each other and brazed in the case of the test material No. 1-3 and the fin material not covered with the brazing filler metal is sandwiched and brazed at the joint of the tube in the case of the test material No. 1-4, a relatively large quantity of the brazing filler metal of a tube flows in the joint and moreover the brazing filler metal is used for the joint with the fins not covered with the brazing filler metal, but the brazing filler metal accumulates also at the joint with the plate, a sufficiently large fillet is formed, and good brazability is obtained.

What is claimed is:

1. An aluminum alloy brazing sheet having a core material comprising an Al—Mn system alloy and a brazing filler metal comprising an Al—Si system alloy containing Fe by 0.45 mass % or less on one surface or both the surfaces of the core material wherein, after subjected to a brazing treatment for 3 minutes at 600° C.: the area ratio of eutectic Si in a cross section of a solidified brazing filler metal is 35% or less; and the grain size in the rolling direction at the center section in the sheet thickness direction of the core material is 80 μm or more.

2. A heat exchanger fabricated by brazing a tube produced by shaping an aluminum alloy brazing sheet according to claim 1 to a plate produced by shaping a material sheet having a core material comprising an aluminum alloy and a brazing filler metal comprising an Al—Si system alloy on one surface or both the surfaces of the core material.

3. A heat exchanger according to claim 2, fabricated by further brazing a fin produced by shaping an aluminum material or an aluminum alloy to the tube.

4. A heat exchanger according to claim 2 or 3, wherein the material sheet is an aluminum alloy brazing sheet according to claim 1.
